(19) United States
(12) Patent Application Publication
(10) Pub. No.: US 2026/0241276 A1
(43) Pub. Date: Aug. 20, 2026

(54) Digital merge game user interface

(71) Applicant: Metacore Games Oy, Helsinki (FI)

(72) Inventors: Javier CALET, Helsinki (FI); Kimmo HIRVONEN, Helsinki (FI); Mikko SILLANPÄÄ, Helsinki (FI); Tiago ROCHA, Helsinki (FI)

(21) Appl. No.: 19/053,476

(22) Filed: Feb. 14, 2025

(51) Int. Cl. A63F 13/40; A63F 13/2145

(52) U.S. Cl. CPC A63F 13/40; A63F 13/2145

(57) ABSTRACT

A digital merge game user interface. A plurality of merge items are displayed on a touch display of a mobile device on a merge board including a finite number of merge item positions so that at most one merge item is displayed in each one of the dedicated merge item positions. A process is performed automatically, including: detecting, using the touch display, an initiating signal given by a user on a first merge item; determining forming of a path by a user along the touch display; identifying during the forming of the path as second merge items all merge items that reside along the path and are identical with the first merge item; visually collecting the first merge item and the second merge items and vacating their respective merge item positions during the forming of the path so creating an appearance of the user collecting the second merge items; and detecting, using the touch display, a releasing signal, and responsively releasing the first merge item and the second merge items.

### TECHNICAL FIELD

The present disclosure generally relates to a digital merge game user interface. The disclosure relates particularly, though not exclusively, to an ergonomically optimized digital merge game user interface.

### BACKGROUND

This section illustrates useful background information without admission of any technique described herein representative of the state of the art.

There are digital merge games in which two merge items are spawned and then merged together to form other game objects. Forming of high-level merge items may require a significant number of spawning and merging operations, which may be time consuming and unergonomic. Along with time, also energy is consumed by extending the time it takes to play a game and keep a digital device running with a display on. Moreover, a high number of separate user interactions tends to also result in trivial pointing errors that may frustrate the user. On the other hand, for playing a game, it is essential not to skip actually playing a game so as not to spoil the fun by turning a game play into watching an animation.

It is desirable to improve the ergonomics and reduce effort of game player and energy consumption of a gaming device on playing a merge game.

### SUMMARY

According to a first example aspect there is provided a method comprising
displaying a plurality of merge items on a touch display of a mobile device on a merge board comprising a finite number of merge item positions so that at most one merge item is displayed in each one of the dedicated merge item positions; and automatically performing a process comprising:
detecting, using the touch display, an initiating signal given by a user on a first merge item;
determining forming of a path by a user along the touch display;
identifying during the forming of the path as second merge items all merge items that reside along the path and are identical with the first merge item;
visually collecting, on the touch display, the first merge item and the second merge items and vacating their respective merge item positions during the forming of the path so creating an appearance of the user collecting the second merge items;
detecting, using the touch display, a releasing signal, and responsively releasing the first merge item and the second merge items.

The process may further comprise, on the releasing of the first merge item and the second merge items, merging pairs formed of the first merge item and one or more second merge items. The merging of the pairs may use the first and second merge items to an extent that at most one merge item out of the first and second merge items remains not paired.

The merging of the pairs may be subject to determining that the releasing signal was given over the merge board.

The process may further comprise positioning the collected first and second merge items in free merge item positions of the merge board responsively to determining that the releasing signal was given outside the merge board.

The process may further comprise positioning merged items formed by the merging of the pairs and any remaining one second merge item into free merge item positions.

The initiating signal may be pressing and holding a finger at the first merge item.

The identifying of the second merge items that reside along the track includes looking up for merge items that reside within a maximum identification distance from the track.

The path may pass through one or more merge items that are not identical with the first merge item. The path may visit outside the merge board without interrupting the process. The first merge item may be determined by looking up for a closest merge item. The looking up for the closest merge item may be spatially constrained. The looking up for the closest merge item may be constrained to merge items that reside within the maximum identification distance.

The maximum identification distance may be at most equal to a multiple of horizontal spacing of the dedicated merge item positions. The multiple may be 0.5; 1; 1.5; 2; 2.5; or 3.

The process may further comprise illustrating the collected first and second merge items during the forming of the path. The illustrating may comprise forming a cluster of the collected first and second merge items during the forming of the path. The illustrating may comprise revolving the cluster during the forming of the path about a current pointing position on the touch display. The cluster may revolve about the first merge item.

The process may further comprise providing a first haptic response on visually collecting the first merge item.

The process may further comprise providing a second haptic response on visually collecting the second merge item. The second haptic response may differ from the first haptic response. The second haptic response may be shorter than the first haptic response so as to improve user perceivably separating events when different second merge items are collected.

The process may further comprise providing a first audible response on visually collecting the first merge item.

The process may further comprise providing a second audible response on visually collecting the second merge item.

The first audible response may depend on a merging level of the first merge item. The first audible response may have a pitch that is the higher the greater the merging level of the first merge item is.

The second audible response may depend on a merging level of the second merge item. The second audible response may have a pitch that is the higher the merging level of the second merge item is.

The merging level of a given merge item may equal to a number of merges that are needed to create that given merge item when starting from a most elementary merge item.

According to a second example aspect there is provided a computer program comprising computer executable program code which when executed by at least one processor causes a mobile device at least to perform the method of the first example aspect.

According to a third example aspect there is provided a computer program product comprising a non-transitory computer readable medium having the computer program of the third example aspect stored thereon.

According to a fourth example aspect there is provided a mobile device comprising means for performing the method of the first example aspect.

The means for performing the method of the first example aspect may comprise at least one processor configured to execute instructions or software code so that the performing of the method is caused.

Any foregoing memory medium may comprise a digital data storage such as a data disc or diskette; optical storage; magnetic storage; holographic storage; opto-magnetic storage; phase-change memory; resistive random-access memory; magnetic random-access memory; solid-electrolyte memory; ferroelectric random-access memory; organic memory; or polymer memory. The memory medium may be formed into a device without other substantial functions than storing memory or it may be formed as part of a device with other functions, including but not limited to a memory of a computer; a chip set; and a sub assembly of a mobile device.

Different non-binding example aspects and embodiments have been illustrated in the foregoing. The embodiments in the foregoing are used merely to explain selected aspects or steps that may be utilized in different implementations. Some embodiments may be presented only with reference to certain example aspects. It should be appreciated that corresponding embodiments may apply to other example aspects as well.

### BRIEF DESCRIPTION OF THE FIGURES

Some example embodiments will be described with reference to the accompanying figures, in which:

FIG. 1 shows a block diagram of a mobile device of an example embodiment;

FIG. 2 shows a schematic view of a merge board of an example embodiment;

FIGS. 3a to 3c show a flow chart of a process that illustrates example embodiments;

FIGS. 4 to 12 show schematic views of the merge board at different times;

FIGS. 13a to 13d show schematic views of different stages of a revolving cluster of an example embodiment.

### DETAILED DESCRIPTION

In the following description, like reference signs denote like elements or steps.

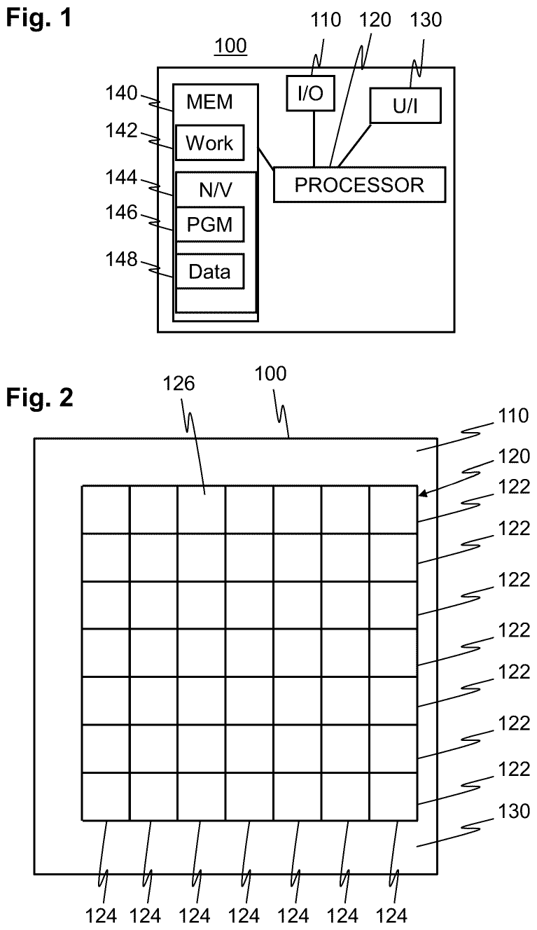

FIG. 1 shows a block diagram of a mobile device 100 according to an example embodiment. In an example embodiment, the mobile device 100 is a handheld device, such as a mobile phone, electronic game device, or tablet computer.

The apparatus 100 comprises a communication interface 110; a processor 120; a user interface 130; and a memory 140.

The communication interface 110 comprises in an embodiment a wired and/or wireless communication circuitry, such as Ethernet; Wireless LAN; Bluetooth; GSM; CDMA; WCDMA; LTE; and/or 5G circuitry. The communication interface can be integrated into the mobile device 100 or provided as a part of an adapter, card or the like, that is attachable to the mobile device 100. The communication interface 110 may support one or more different communication technologies. The mobile device 100 may also or alternatively comprise more than one of the communication interfaces 110.

In this document, a processor may refer to a central processing unit (CPU); a microprocessor; a digital signal processor (DSP); a graphics processing unit; an application specific integrated circuit (ASIC); a field programmable gate array; a microcontroller; or a combination of such elements.

The user interface may comprise a circuitry for receiving input from a user of the mobile device 100, e.g., via a keyboard; graphical user interface shown on the display of the mobile device 100; speech recognition circuitry; or an accessory device; such as a headset; and for providing output to the user via, e.g., a graphical user interface or a loudspeaker.

The memory 140 comprises a work memory 142 and a persistent memory 144 configured to store computer program code 146 and data 148. The memory 140 may comprise any one or more of: a read-only memory (ROM); a programmable read-only memory (PROM); an erasable programmable read-only memory (EPROM); a random-access memory (RAM); a flash memory; a data disk; an optical storage; a magnetic storage; a smart card; a solid-state drive (SSD); or the like. The mobile device 100 may comprise a plurality of the memories 140. The memory 140 may be constructed as a part of the mobile device 100 or as an attachment to be inserted into a slot; port; or the like of the mobile device 100 by a user or by another person or by a robot. The memory 140 may serve the sole purpose of storing data or be constructed as a part of a mobile device 100 serving other purposes, such as processing data.

A skilled person appreciates that in addition to the elements shown in FIG. 1, the mobile device 100 may comprise other elements, such as microphones; displays; as well as additional circuitry such as input/output (I/O) circuitry; memory chips; application-specific integrated circuits (ASIC); processing circuitry for specific purposes such as source coding/decoding circuitry; channel coding/decoding circuitry; ciphering/deciphering circuitry; and the like. Additionally, the mobile device 100 may comprise a disposable or rechargeable battery (not shown) for powering the mobile device 100 if external power supply is not available.

FIG. 2 shows a schematic view of a merge board 100 of an example embodiment. The merge board 100 comprises a header area 110 for a first set of game information, a footer area 130 for a second set of game information, and a grid formed of a plurality of rows 122 and columns 124 to define a plurality of merge item positions 126, only one of which is drawn into FIG. 2 for clarity.

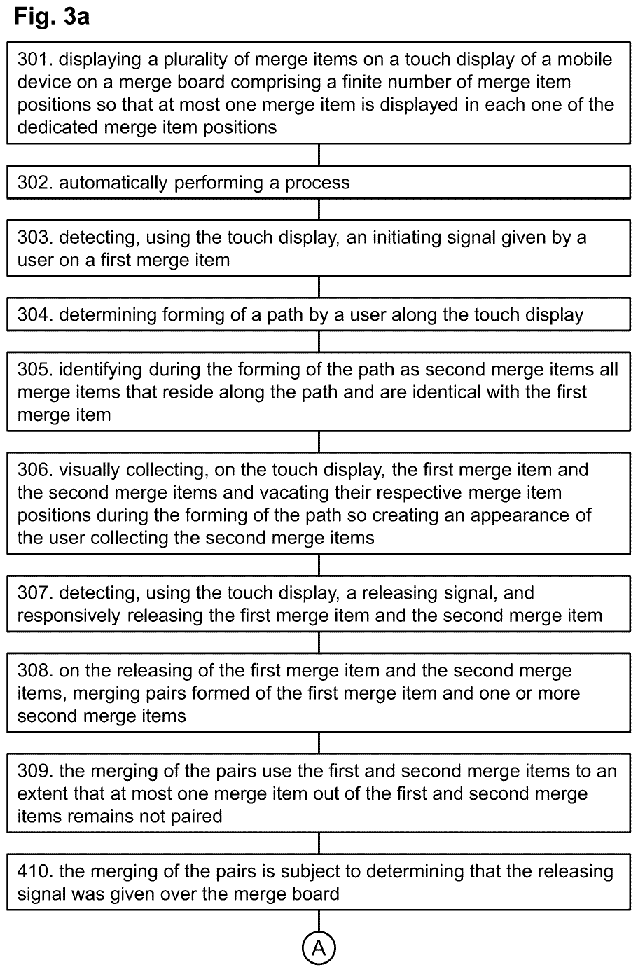

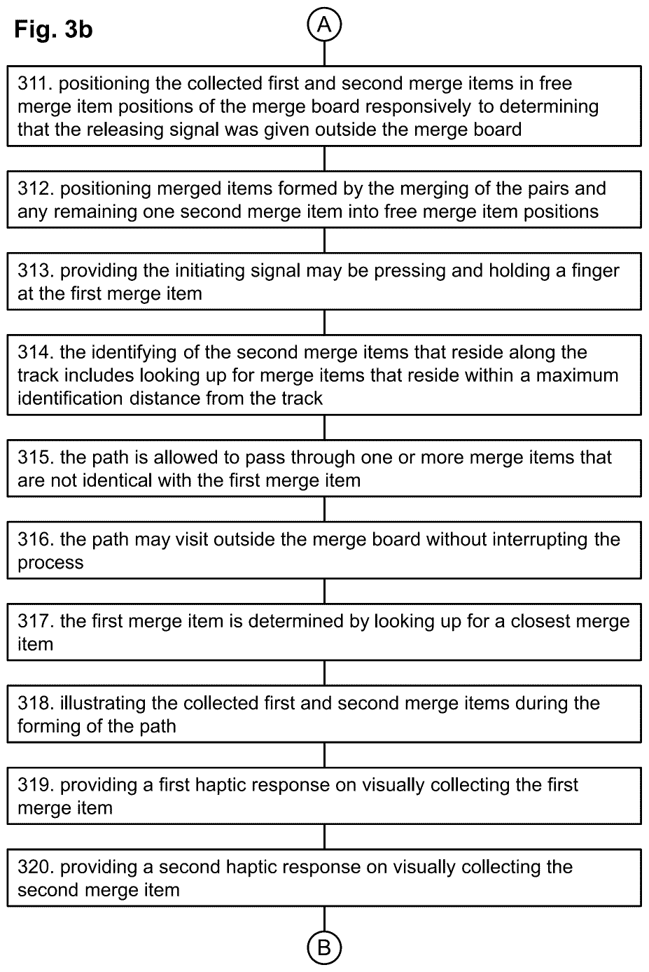

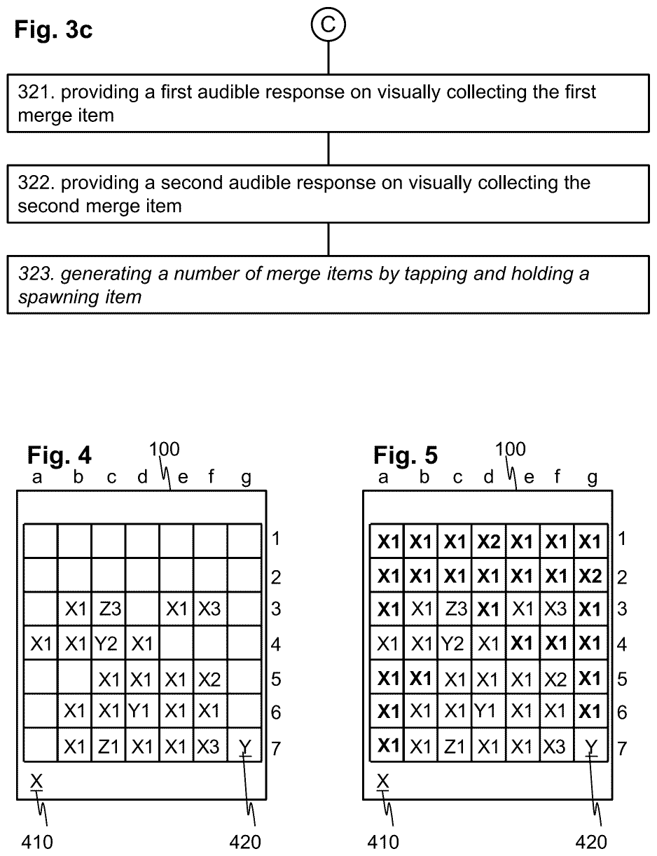

Let us next look into a simplified flow chart of FIGS. 3a to 3c representing a process illustrating various example embodiments using schematic screenshots of FIG. 4 onward for further reference.

FIG. 4 onwards show schematic views of the merge board at different times. For ease of referencing, the grid columns and rows are labelled. For example, in an initial situation shown in FIG. 4, there are a plurality of level merge items of different chains X, Y, Z and of different merge levels 1 to 3, such as X1, Y2, and Z3 in positions b3, c4, and c3, respectively.

FIG. 4 further shows some optional controls, such as a first spawning item 410 for generating new merge items of a first chain X, and a second spawning item 420 for generating new merge items of a second chain Y. In an example embodiment, the spawning items are visually highlighted for the user. These spawning items may reside on the merge board, as illustrated by the second spawning item 420, or outside the merge board as illustrated by the first spawning item 410.

Let us assume that the user has generated new merge items of the first chain by using the first spawning item 410, for example.

FIG. 5 shows an example in which new merge items have been generated to fill all empty merge item positions. These new merge items are marked by X indicative of the first chain, as produced by the first spawning item 410 that spawns merge items of the first chain. Most of these new merge items are also of the first merge level 1, although also some examples of higher levels are drawn (X2). The new merge items are highlighted here by a bold typeface, whereas in a normal game the new merge items may appear exactly same as earlier produced merge items of same chain and merge level.

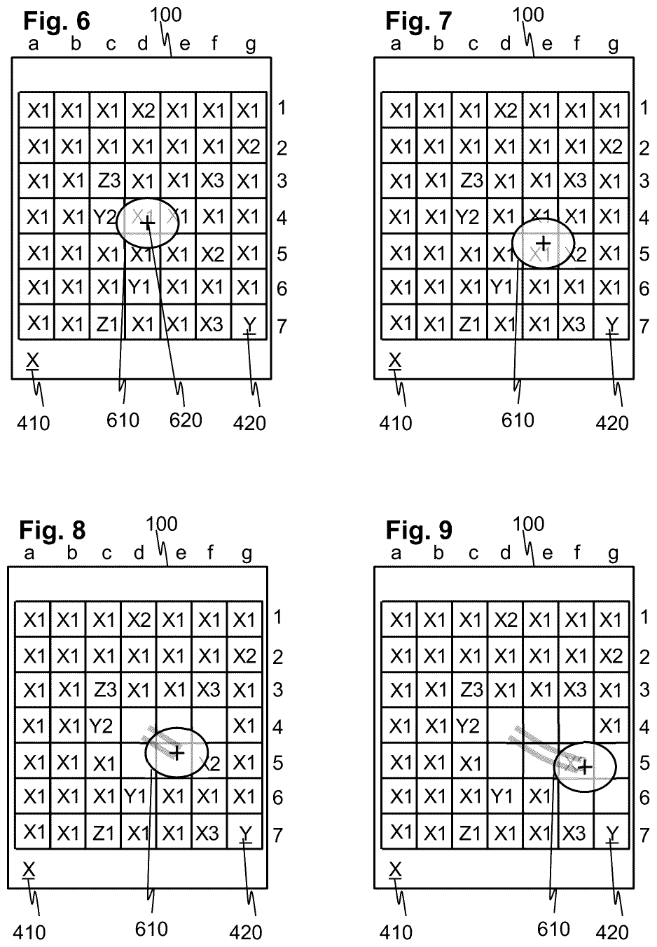

FIG. 6 shows a screen view of a situation at a subsequent time when the user points at one of the merge items, denoted as a first merge item. That first merge item could be of any chain and any merge level or simply said any one of the merge items displayed on the merge board or in the grid. The user typically uses a smart phone as a mobile device, and a finger as a pointing object. An oval shape is drawn to represent a contact area 610 of a finger on the merge board at this point of time. A center 620 is also drawn for the contact area 610.

The method of FIGS. 3a to 3c commences by
301. displaying a plurality of merge items on a touch display of a mobile device on a merge board comprising a finite number of merge item positions so that at most one merge item is displayed in each one of the dedicated merge item positions.

FIG. 5 exemplifies one scenario after this step, with the merge board filled so that there are no empty merge item positions. Notably, this need not be the case: the scenario illustrated by FIG. 4 is also possible for the situation after step 301.

Next, an automatic process is performed:
302. Automatically Performing a Process.

In an example embodiment, the process comprises
303. detecting, using the touch display, an initiating signal given by a user on a first merge item.

FIG. 6 illustrates the initial signal given by the user so that the user puts a finger onto one of the merge items on the merge board. In effect, the user now selects the chain and the merge level for subsequent collection of identical merge items. The center of the contact area 620 of the finger is here at merge item position d4, at merge item X1. This particular merge item is now denoted as a first merge item.

In an example embodiment, the process further comprises
304. determining forming of a path by a user along the touch display.

FIG. 7 shows a portion of the path while being generated, and current position e5 of the contact area of the finger on the touch screen.

In an example embodiment, the process further comprises
305. identifying during the forming of the path as second merge items all merge items that reside along the path and are identical with the first merge item. Looking at FIG. 7, the new destination position e5 is clearly on the path, but also the proximate positions d5, e4, and e5, f4 and f5 may be seen to reside on this path, depending on an implementation. In sake of simplicity, it is here assumed that merge items along the path are defined as those residing any merge item position that even partially falls under the contact area or a normalized shape such as the oval 610. However, since position f5 accommodates a different merge item X2 (not X1), that merge item would not be identified as one of the second merge items.

In an example embodiment, the process further comprises
306. visually collecting, on the touch display, the first merge item and the second merge items and vacating their respective merge item positions during the forming of the path so creating an appearance of the user collecting the second merge items. In case of the situation of FIG. 7, the merge items that are considered as the second merge items are those that resided in positions d5, d6, and e4. These positions and the position of the first merge item d4 are now vacated as the first and second merge items are collected.

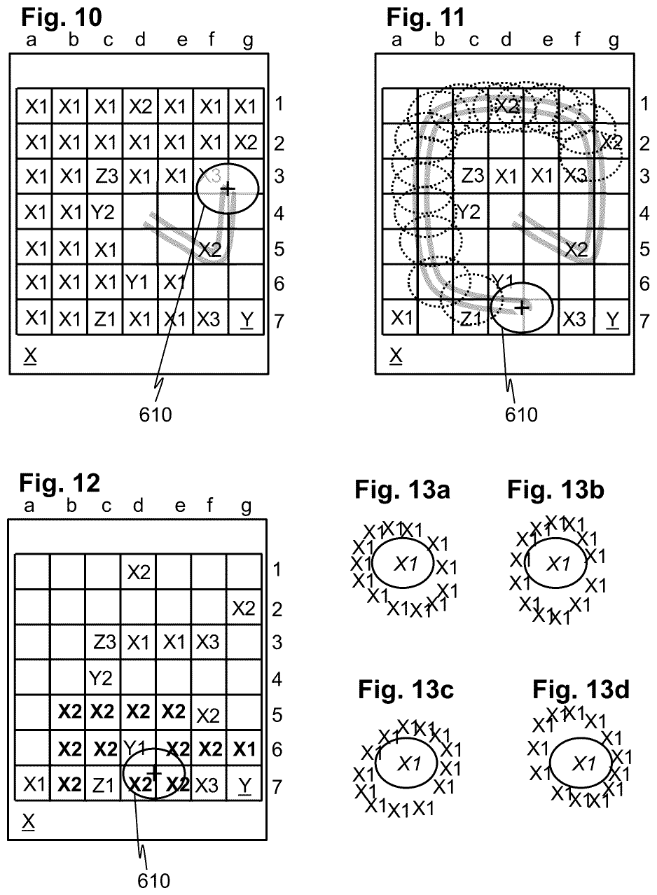

FIGS. 9 to 11 illustrate further snapshots of forming of a whole path of one scenario. FIG. 11 further illustrates a plurality of intermediate positions by dashed ovals to represent how different merge item positions have been collected at different phases of the forming of the path. Notably some merge items remained uncollected, because either they were not identical with the first merge item, or resided too far to be along the path.

In an example embodiment, the process further comprises
307. detecting, using the touch display, a releasing signal, and responsively releasing the first merge item and the second merge item.

FIG. 12 illustrates the merge board after collecting the first and second merge items, when the releasing signal was issued by lifting the finger, for example. The final position of the contact area or its normalized area, such as the oval 610, is also shown.

In an example embodiment, the process further comprises
308. on the releasing of the first merge item and the second merge items, merging pairs formed of the first merge item and one or more second merge items.

In case of FIG. 12, the number of collected merge items (one first item and a plurality of second merge items) is the total number of merge item positions less those still occupied, i.e., 36−13=23.

In an example embodiment, the process further comprises that
309. the merging of the pairs use the first and second merge items to an extent that at most one merge item out of the first and second merge items remains not paired. With a total of 23 merge items, for example, 22 merge items are merged (from first merge level X1 to second merge level X2), while one remains as it was, here as X1.

In an example embodiment, the process further comprises that
310. the merging of the pairs is subject to determining that the releasing signal was given over the merge board. If, for example, the path ended at the point referred to by reference sign 410, outside the merge board, then the merging would be cancelled.

In an example embodiment, the process further comprises
311. positioning the collected first and second merge items in free merge item positions of the merge board responsively to determining that the releasing signal was given outside the merge board. All the collected merge items would be returned to free positions. Since they all are identical, the result would be exactly same in this case—when the merge board was originally full of merge items—as in FIG. 5. However, if the starting scenario were that of FIG. 4, depending implementation, the merge items could be positioned to other than their original merge item positions, for example, to nearest free merge item positions. Alternatively, the merge items could be returned to occupy same merge item positions that were occupied before the collecting of the merge items.

In an example embodiment, the process further comprises
312. positioning merged items formed by the merging of the pairs and any remaining one second merge item into free merge item positions. This applies to the case where the merge items are not returned to the merge board, but instead merged and the merged items are positioned into free merge item positions.

FIG. 13 illustrates a scenario of an outcome following from step 312. 11 merged items, X2, are positioned in free merge item positions at the end point of the path, whereas the remnant X1 is positioned to a remaining free position, or vice versa: the remnant may be positioned first and the other merged items then. These positioned merge items are highlighted here by a bold typeface, while in a game, no such highlighting is necessarily made.

In an example embodiment, the process further comprises
313. providing the initiating signal may be pressing and holding a finger at the first merge item. For example, the user rests a finger onto position d4 in the scenario of FIG. 6.

In an example embodiment, the process further comprises that 314. the identifying of the second merge items that reside along the track includes looking up for merge items that reside within a maximum identification distance from the track. At simplest this can be so that a distance is computed between the path or intermediate contact centers and surrounding merge grid positions or merge items, and any merge items within a predefined maximum distance are deemed to be along the path.

In an example embodiment, the process further comprises that
315. the path is allowed to pass through one or more merge items that are not identical with the first merge item.

In an example embodiment, the process further comprises that
316. the path may visit outside the merge board without interrupting the process.

In an example embodiment, the process further comprises that
317. the first merge item is determined by looking up for a closest merge item. That is, on giving the initiating signal, the user may not actually hit onto any merge item. It may help to improve the user interface to yet select a closest merge item as if the user had hit that. In an example embodiment, the looking up for the closest merge item is spatially constrained. In an example embodiment, the looking up for the closest merge item is constrained to merge items that reside within the maximum identification distance.

In an example embodiment, the maximum identification distance is at most equal to a multiple of horizontal spacing of the dedicated merge item positions. In an example embodiment, the multiple is 0.5; 1; 1.5; 2; 2.5; or 3.

In an example embodiment, the process further comprises
318. In at least some embodiments, visually collecting may comprise, for example, illustrating the collected first and second merge items during the forming of the path. The illustrating may comprise forming a cluster of the collected first and second merge items during the forming of the path. The illustrating may comprise revolving the cluster during the forming of the path about a current pointing position on the touch display. The cluster may revolve about the first merge item.

FIGS. 13a to 13d show different stages of a revolving cluster of an example embodiment. By forming the cluster non-circular, such as an oval or rectangular group, and/or by revolving the cluster about a point off a center of the cluster, portions of the cluster can be made easily visible to the user at times when the cluster extends more from under the finger to a field of view of the user.

In an example embodiment, the process further comprises
319. providing a first haptic response on visually collecting the first merge item.

In an example embodiment, the process further comprises
320. providing a second haptic response on visually collecting the second merge item. The second haptic response may differ from the first haptic response. The second haptic response may be shorter than the first haptic response so as to improve user perceivably separating events when different second merge items are collected.

In an example embodiment, the process further comprises
321. providing a first audible response on visually collecting the first merge item.

In an example embodiment, the process further comprises
322. providing a second audible response on visually collecting the second merge item.

In an example embodiment, the first audible response depends on a merging level of the first merge item. In an example embodiment, the first audible response has a pitch that is the higher the greater the merging level of the first merge item is.

In an example embodiment, the second audible response depends on a merging level of the second merge item. In an example embodiment, the second audible response has a pitch that is the higher the greater the merging level of the second merge item is.

In an example embodiment, the merging level of a given merge item equals to a number of merges that are needed to create that given merge item when starting from a most elementary merge item.

In an example embodiment, the process further comprises
23. generating a number of merge items by tapping and holding a spawning item. In an example embodiment, the merge items are generated at a given rate until the tapping and holding of the spawning item is interrupted or all free merge grid positions would become occupied by the generated merge items. In an example embodiment, the generated merge items are of one or more merging levels.

The drawings and corresponding descriptions outline the flexibility and applicability of various embodiments and use cases, demonstrating how the different example embodiments can be applied to achieve efficient generating and merging operations of merge items in a user-interactive environment on a mobile device. It is also demonstrated how the progression of game events can be maintained on a suitably steep curve to make the game interesting and avoiding unnecessary consumption of time and energy to complete a game. In particular, various embodiments may reduce consumption of time and energy to complete an initial phase of a merge game.

Any of the afore described methods, method steps, or combinations thereof, may be controlled or performed using hardware; software; firmware; or any combination thereof. The software and/or hardware may be local; distributed; centralized; or any combination thereof. Moreover, any form of computing, including computational intelligence, may be used for controlling or performing any of the afore described methods, method steps, or combinations thereof. Computational intelligence may refer to, for example, any of artificial intelligence; neural networks; fuzzy logic; machine learning; genetic algorithms; evolutionary computation; or any combination thereof.

Various embodiments have been presented. It should be appreciated that in this document, words comprise; include; and contain are each used as open-ended expressions with no intended exclusivity.

The foregoing description has provided by way of non-limiting examples of particular implementations and embodiments a full and informative description of the best mode presently contemplated by the inventors for carrying out the invention. It is, however, clear to a person skilled in the art that the invention is not restricted to details of the embodiments presented in the foregoing, but that it can be implemented in other embodiments using equivalent means or in different combinations of embodiments without deviating from the characteristics of the invention.

Furthermore, some of the features of the afore-disclosed example embodiments may be used to advantage without the corresponding use of other features. As such, the foregoing description shall be considered as merely illustrative of the principles of the present invention, and not in limitation thereof. Hence, the scope of the invention is only restricted by the appended patent claims.

1. A method comprising
displaying a plurality of merge items on a touch display of a mobile device on a merge board comprising a finite number of merge item positions so that at most one merge item is displayed in each one of the dedicated merge item positions; and automatically performing a process comprising:
detecting, using the touch display, an initiating signal given by a user on a first merge item;
determining forming of a path by a user along the touch display;
identifying during the forming of the path as second merge items all merge items that reside along the path and are identical with the first merge item;
visually collecting, on the touch display, the first merge item and the second merge items and vacating their respective merge item positions during the forming of the path so creating an appearance of the user collecting the second merge items; and
detecting, using the touch display, a releasing signal, and responsively releasing the first merge item and the second merge items.

2. The method of claim 1, wherein the process further comprises, on the releasing of the first merge item and the second merge items, merging pairs formed of the first merge item and one or more second merge items.

3. The method of claim 1, wherein the merging of the pairs is subject to determining that the releasing signal was given over the merge board.

4. The method of claim 1, wherein the process further comprises positioning the collected first and second merge items in free merge item positions of the merge board responsively to determining that the releasing signal was given outside the merge board.

5. The method of claim 1, wherein the process further comprises positioning merged items formed by the merging of the pairs and any remaining one second merge item into free merge item positions.

6. The method of claim 1, wherein the initiating signal indicates pressing and holding a finger at the first merge item.

7. The method of claim 1, wherein the identifying of the second merge items that reside along the track includes looking up for merge items that reside within a maximum identification distance from the track.

8. The method of claim 7, wherein the maximum identification distance is at most equal to a multiple of horizontal spacing of the dedicated merge item positions, wherein the multiple is 3.

9. The method of claim 1, wherein the path is allowed to pass through one or more merge items that are not identical with the first merge item.

10. The method of claim 1, wherein the first merge item is determined by looking up for a closest merge item.

11. The method of claim 1, wherein the process further comprises illustrating the collected first and second merge items during the forming of the path.

12. The method of claim 1, wherein the process further comprises providing a first haptic response on visually collecting either the first merge item or the second merge item.

13. The method of claim 1, wherein the process further comprises providing an audible response on visually collecting either the first merge item or the second merge item.

14. The method of claim 13, wherein the audible response on visually collecting the first merge item differs from the audible response on visually collecting the second merge item.

15. The method of claim 13, wherein the audible response depends on a merging level of the first merge item.

16. The method of claim 1, wherein the merging level of a given merge item equals to a number of merges that are needed to create that given merge item when starting from a most elementary merge item.

17. The method of claim 1, wherein the method further comprises generating a number of merge items by tapping and holding a spawning item.

18. The method of claim 17, wherein the merge items are generated at a given rate until the tapping and holding of the spawning item is interrupted or all free merge grid positions would become occupied by the generated merge items.

19. A non-transitory memory medium comprising a computer program, the computer program comprising computer executable program code which when executed by at least one processor causes a mobile device at least to perform the method of claim 1.

20. A mobile device comprising means for performing the method of claim 1.
